(19) United States
(12) Patent Application Publication
(10) Pub. No.: US 2003/0004842 A1
(43) Pub. Date: Jan. 2, 2003

(54) Cardless globility database

(76) Inventors: Trichita G. Williams, Carefree, AZ (US); Michael G. Williams, Carefree, AZ (US)

Correspondence Address: RICHARD R. MYBECK, Post Office Box 5540, Scottsdale, AZ, 85258-1234, US

(21) Appl. No.: 09/895,730

(22) Filed: Jul. 2, 2001

(51) Int. Cl. G06F 17/60; H04K 1/00; H04L 9/00

(52) U.S. Cl. 705/35; 705/51

(57) ABSTRACT

The present invention comprises a system for completing a myriad of personal, commercial and/or financial transactions based solely on the idiosyncratic correlation of at least three of a customers confidential identifiers, none of which are accessible to third parties by inspecting public records.

The present invention relates to a system for conducting business and other monetary transactions on an international scale which system totally eliminates the need for paper money, coins, plastic cards, tokens and like devices and utilizes, instead an encrypted centralized database incorporating at least three independent but idiosyncratic identifiers to insure the security of each user thereof and their assets entrusted thereto.

### BACKGROUND OF THE INVENTION

The crime of “identity theft” has taken on a new dimension in recent months as criminals have discovered ways of obtaining an individual's allegedly “confidential” data including social security number, birth date, driver's license number and mother's maiden name, all of which are available to the knowledgeable somewhere on the Internet, among “public records” or by simply stealing the victim's wallet/purse which usually contains a driver's license, a social security card club membership card, insurance cards and the like, all of which contain one or more entries of this vital data. In addition, some states such as Arizona have further enhanced the ease by which identity theft can be accomplished by using an applicant's social security number on its driver's license.

Thus a strong need exist to provide a system of personal/commercial transactions which is not predicated upon cash, cards, hardware or otherwise generally available information and which not only protects an individual from identity theft, but also greatly facilitates the ability of one to complete a personal/commercial transaction, transfer monetary funds or otherwise manage one's personal/business monetary account assets without fear of third party intervention.

### BRIEF SUMMARY OF THE INVENTION

The present invention comprises a system for completing a myriad of personal/commercial transactions based solely on the idiosyncratic correlation of at least three of a customer's encryptable and confidential identifiers, the correlation of which is not accessible to third parties, even if they inspect the public records.

More particularly, the present invention involves the novel and unique combination of currently available technology to provide a global database for receiving a storing at least three independent items of each user's special identification, namely, a self-selected encrypted fingerprint, encrypted photograph and a self-selected personal identification number (PIN). Additional data such as Social Security number, mother's maiden name, birthday, city of birth may be included, if desired, but as will be shown, they are neither essential nor will the system rely on this publicly available data.

The central database will contain all data for each customer and include means, using currently available technology, for communicating with remote terminals at the point of transaction where the customer will privately input his encrypted fingerprint and PIN to initiate that process. When the customer has entered his/her encrypted fingerprint and PIN, the information will be transmitted to the central database which will verify both the print and the PIN and will immediately return a verdict of “valid” or “invalid” to the point of sale terminal. When valid, the central database will immediately send a encrypted photograph of the registered user to the point-of-sale terminal where the merchant can visually compare the image with the person before him/her. A question will be asked “if updates of individual are necessary?” eyes, mouth, nose, face, ears, hair, etc. If so, updates will be typed in at POS and updater will enter cashier with dual authority code to make updates. However, failure to match the encrypted photograph ends the transaction. When the image is accurate, the transaction can be completed as will be herein after described in greater detail.

Accordingly, it is a prime object of the present invention to provide a global financial transaction system which utilizes at least three items of a customer's esoteric information to confirm that the customer is who they purport to be and determine whether that customer's account actually has sufficient assets to complete the transaction.

These and still further objects as shall hereinafter appear are readily fulfilled by the present invention in a remarkably unexpected manner as will be readily discerned from the following detailed description of an exemplary embodiment thereof especially when read in conjunction with the accompanying drawing.

### BRIEF DESCRIPTION OF DRAWINGS

In the drawing:

FIG. 1 is a schematic showing of a global database system embodying the present invention.

### DETAILED DESCRIPTION OF THE PREFERRED EMBODIMENT

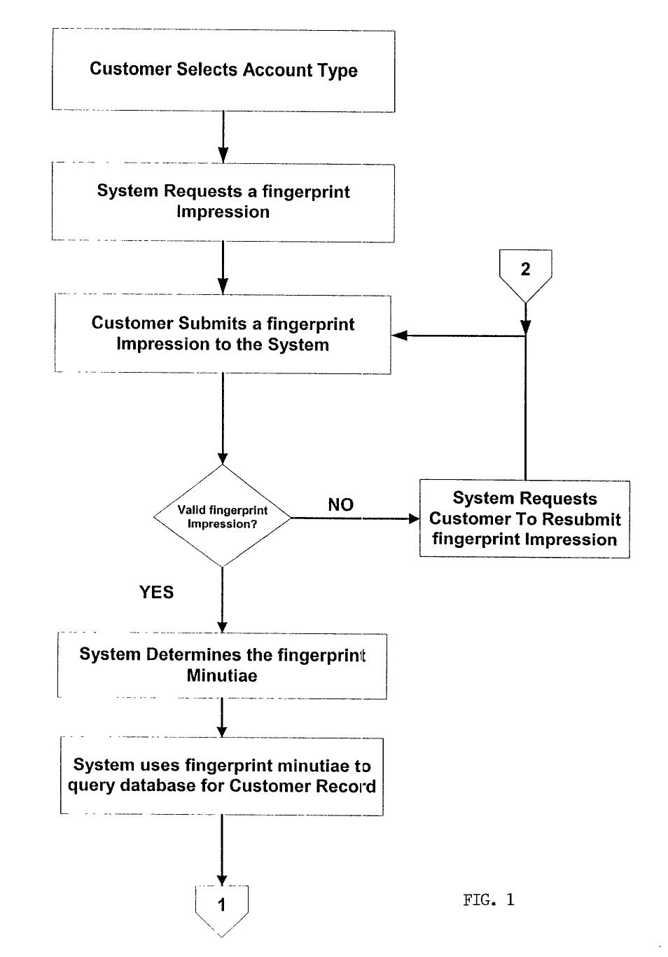

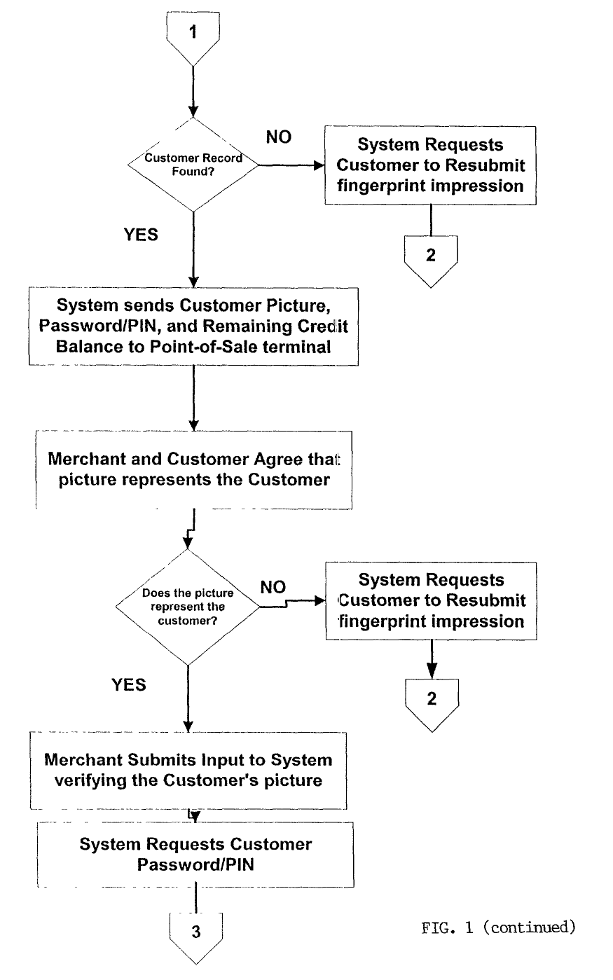

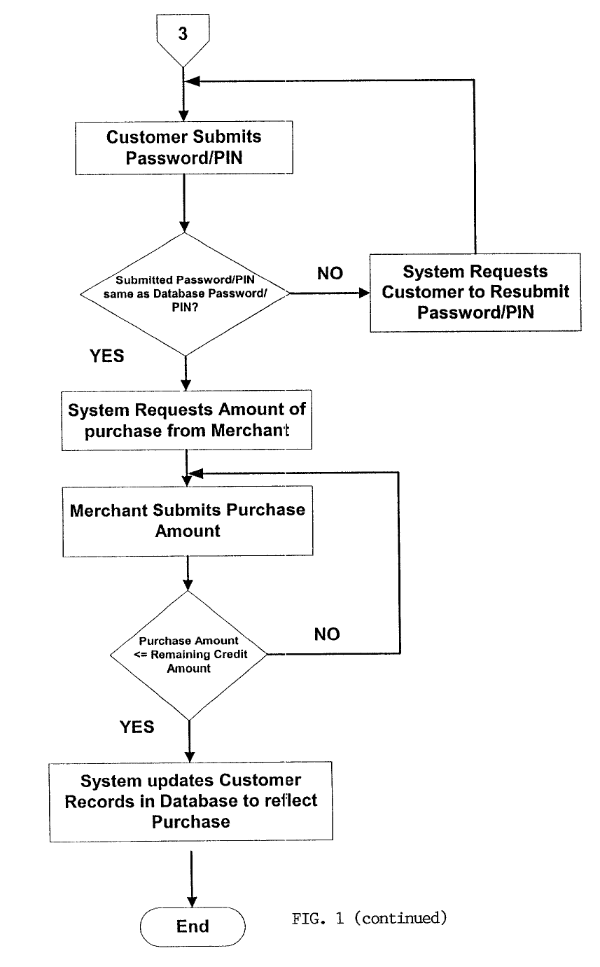

Referring now to FIG. 1 which schematically illustrates the sequence of the system from the perspective of the point of sale terminal, the practical use of the present system will be described from the perspective of a person (customer) who wishes to make a purchase at a merchant's store. The merchant and the customer interact with a Point-of-Sale (POS) terminal device with a small display screen, a keyboard or keypad, and encrypted fingerprint impression hardware. The POS terminal and associated systems will minimally utilize the customer's encrypted fingerprint, encrypted photograph, and Password/PIN to complete a financial transaction at the merchant's facility.

A display screen (e.g. video monitor) at the store site is used to display textual information and software prompts to the customer and to the merchant. It also, will display a picture of the customer of sufficient quality to enable the merchant to verify that the person making the purchase is indeed the person represented by the picture. The keyboard or keypad capability of the system will allow the customer to enter his/her unique Password/PIN and other information needed to complete the transaction. The encrypted fingerprint hardware will take an impression of the customer's encrypted fingerprint used to help verify the customer.

The POS terminal contains the necessary software that will direct the customer and the merchant through a series of sequential steps to complete the transaction. The flowchart of a typical transaction is shown in FIG. 1.

The transaction as shown, begins with the customer selecting the account that they would like to use. For example, the customer may choose to use American Express (AMEX) for their purchases. The POS will have the capability to allow the customer to select any of the major financial systems to which he/she subscribes (accounts, not cards) such as AMEX, Visa, or Master Card “accounts”, both debit or credit accounts, as well as their checking and savings accounts maintained at the Bank of his/her choice.

The POS terminal will capture customer encrypted fingerprint impressions and encode them in a form such that they can be transmitted using known technology to a central database, which will automatically search the centralized database for an existing encrypted fingerprint. If the customer has previously registered with the system, an encoded/encrypted version of the encrypted fingerprint will exist in the database. If not, the system can not be used until such registration has been perfected and the immediate transaction will be rejected.

As indicated, the centralized database server is connected to all of the POS terminals by using either dedicated communication lines or current Internet technology. As the Wireless communication technologies evolve, they too can be used to connect the POS terminals to the database server. Because of the number of anticipated transactions the database will serve within the system, it is anticipated that the central system may require a number of distributed database servers, each to be strategically located in a different geographic area, to minimize the time for any particular transaction to be evaluated and, when appropriated, completed.

The security of the system depends upon the absolute correlation of at least three idiosyncratic indicia, preferably the customer's Password/PIN, encrypted fingerprint minutiae, and the customer encrypted picture. These three components are linked together by the interaction that the customer and merchant have within the system. This technology is likewise current knowledge and need not be further detailed here.

Validating or verifying a customer using encrypted fingerprint minutiae requires, inter alia, that the customer's encrypted fingerprint impression obtained at the POS when the financial transaction is contemplated is carefully compared to one that was previously stored in the central database. The encrypted fingerprint impression stored in the central database is the initial encrypted fingerprint impression and a picture of the customer obtained at the time of enrollment. The central database, sometimes referred to as “the verification agency” can also be used to store and ultimately confirm digital certificates/encryptions for people who desire to privately work on the Internet using data encryption techniques not necessarily associated with sales but rather with the transmittal of a confidential and tradesecret information. Such customers will register with the verification agency to have their picture, encrypted fingerprint impressions and PIN taken which will be transmitted via the system to be recorded into the central database. This information is, of course, then correlated to the customer's account, data that provides additional security when the customer wishes to perform a transaction with this account.

The image of the encrypted fingerprint is converted to a record of minutiae by a series of known encrypted fingerprint processing algorithms. The ridge ends and bifurcations (minutiae) of the encrypted fingerprint image are identified and encoded. The minutiae, in effect, describe the encrypted fingerprint.

Furthermore, the customer does not have to be concerned about the encrypted fingerprint being sent to a destination over which they have little or no control because the minutiae comprises a code/encryption that is used to compare the encrypted fingerprints at the central data base, and the system requires a match with the encrypted fingerprint delivered at the POS before anything else can occur. The amount of data needed to capture the details is relatively small for the encrypted fingerprint image. The transmittal of the encrypted photograph is contingent upon the encrypted fingerprint match.

The encrypted fingerprint minutiae are sufficient to identify a unique encrypted fingerprint. However, the original encrypted fingerprint cannot be recreated/violated from the minutiae. Privacy issues involving the capture of encrypted fingerprints can be avoided while maintaining security over the customer's financial transactions (because of the encryption processing). In addition, since the data needed to identify a encrypted fingerprint is small, the time to complete a database search for the corresponding encrypted fingerprint is relatively small which helps assure that the response times are acceptable to the customer and the merchant.

There are several commercial manufactures who currently produce the needed hardware to capture and record a customer's encrypted fingerprint impressions. Likewise, software which can encode the encrypted fingerprint data into the encrypted fingerprint minutiae records in a central data base, store those records in the database and communicate between the database and the appropriate POS terminal the results of the search.

The customer's picture is also stored in the database in a compressed graphically encrypted format such as JPEG or JPEG 2000. The compressed formats take a sufficiently high quality encrypted photograph needed to identify a customer and reduce the data needed to store the encrypted photograph. The encryption process will not allow Internet violation or changes to encrypted photographs because of encoding. The compressed image takes less time to be sent to the POS terminals by the system. The POS terminal will have the ability to render or display the customer's compressed image so that it can be readily used to identify the customer. Note that it is the customer's responsibility to maintain a current encrypted photograph in the system when change of appearance occurs through aging, accident, or pure vanity.

When the customer starts the financial “account” transaction, the encrypted fingerprint minutiae are sent by the POS terminal to the database, which searches for a matching record. If a matching record is found, the system will send the customer's picture, Password/PIN, and the remaining account balance to the POS terminal for approval. The POS terminal uses this information to complete the transaction. By sending the rest of the verifying information at the same time, the system eliminates the need for repeated interactions between the POS terminal and the database. As previously mentioned, the system should minimize the number of interactions or sessions between the POS terminals and the database in order to achieve satisfactory response time for the verification and completion of transactions. As indicated above, the merchant will use the customer's picture to verify the person attempting to make a purchase. Update photo, if necessary, will use the following procedure: Dual control during update; Supervisor and terminal attendant, authority codes and terminal attendant and employee number will be necessary to update system and maintain security. If the picture does not match the customer, the transaction will terminate at this point. The POS terminal internally retains the Password/PIN and the “account” balance, which will be deleted if the transaction terminates. Once the picture is verified, the customer will authorize purchase amount, transaction “account” will complete purchase.

Other uses of this Service Distribution System are available and it is not limited to purchases only. Thus, this system will allow for the transfer of “account” funds, the automatic payment of mortgages, rent and other billing.

Let us now consider one cycle of the present invention where a customer, indicating that he/she has an active account with the system, desires to make a purchases from a merchant who is part of the network.

The customer approaches the terminal and selects his/her account type (VISA®, AMEX®, MasterCard®, Discover®, Bank account and the like). The system then requests the customer to input an impression of the customer's encrypted fingerprint. Note that at this point, the print of selected encrypted finger is in the system is only known by the customer.

The customer then places the appropriate fingertip on the print-receiver and the impression is immediately transmitted to the system where it is evaluated. If the system does not find the encrypted fingerprint, it will request the customer to resubmit the image. If the second transmission fails to correlate to an existing customer record in the database, the session is terminated.

On the other hand, if the encrypted fingerprint is found to correlate to an existing customer record, the central data system will transmit the customer's picture. Once a picture is transmitted which the merchant and the customer agree represents the customer, the merchant signals the system to verify the customer's picture and the customer enters his/her unique password/PIN. The system will evaluate the password/PIN. If it does not jibe, the customer is invited to resubmit it.

When the password/PIN is verified as matching the data associated with customer's account, the system then requests the merchant to enter the amount of the purchase into the system. If the purchase amount exceeds the customer's “account” balance, the system reports, “Insufficient funds”. If the purchase amount is less than the customer's existing “account” balance, the purchase is approved and the amount of the purchase is deducted from the customer's account and credited to the merchant's appropriate account.

In those rare occurrences when the customer is physically challenged and thus without fingers to print, an alternative indicator may be used which is likewise idiosyncratic to the customer such an image might be a biometric reproduction of the customer's iris or the like which would also be stored in the master data base.

Other applications and aspects of the present invention merit mention. For example, when used at ticket windows such as airline, buses and trains, the POS terminal upon verification of the passenger's account and delivery of the appropriate boarding pass can be adapted to print out the encrypted fingerprint as a luggage identification label for attachment to the passenger's luggage or other belongings which will enable it to be traced back to the owner and will be retained in system for 48 hours or until destination is reached and automatically deleted.

Other applications involve the identification of traffic violators, accident victims, fugitives and the like which while possibly involving the transmittal of all encrypted fingerprints in the case of a non-cooperative person, can none the less be used to identify the person under consideration if they previously used the system for any purpose.

One last aspect occurs when a transaction is completed but it is apparent that the registrant's photo is out-of-date, an updated encrypted photograph can be obtained at a local verification agency.

From the foregoing, it is readily apparent that a useful embodiment of the present invention has been herein described and illustrated which fulfills all of the aforestated objectives in a remarkably unexpected fashion. It is of course understood that such modifications, alterations and adaptations as may readily occur to the artisan confronted with this disclosure are intended within the spirit of this disclosure which is limited only by the scope of the claims ed hereto.

1. A cardless global database system comprising:
a central database having the ability to receive, store and access a plurality of idiosyncratic indicators for each of a number of discrete individual accounts to input hereto including means for selectively receiving and evaluating data transmitted thereto and means for transmitting an evaluation of said data and related information therefrom;
a plurality of point-of-sale terminals, each independently and discretely connected to said central database for the purpose of transmitting information thereto and receiving said evaluations and related information therefrom; and
input means for receiving and encoding a user's idiosyncratic indicia for and inputting said indicia into said point-of-sale terminal for transmittal to the central database for acceptance or rejection thereby.

2. A cardless global database system according to claim 1 in which said idiosyncratic indicators comprise a user's encrypted fingerprint, encrypted photograph and personal identification number (PIN).

3. A cardless global database system according to claim 2 in which said encrypted fingerprint is encrypted.
